(19) United States
(12) Patent Application Publication
(10) Pub. No.: US 2018/0183807 A1
(43) Pub. Date: Jun. 28, 2018

(54) METHOD FOR AUDITING CLOUD ACCESS IN REAL TIME

(71) Applicant: Tidetime Sun Ltd., Chai Wan (HK)

(72) Inventor: Gwan-Hwan Hwang, Hsinchu County (TW)

(21) Appl. No.: 15/686,438

(22) Filed: Aug. 25, 2017

(30) Foreign Application Priority Data
Dec. 27, 2016 (TW) 105143444

(51) Int. Cl. H04L 29/06; G06F 17/30; H04L 9/06

(52) U.S. Cl. CPC H04L 63/105; H04L 9/0643; G06F 17/30327; G06F 17/3033

(57) ABSTRACT

A method for auditing cloud access in real time includes steps of Step 1: client obtains necessary information from a synchronization server (SYS), by executing a library comprising index function Γ required by program, and saving a root hash value R of a fully binary hash tree (FBHTREE) in SYS; Step 2: the client obtains leave node position corresponding to FBHTREE and corresponding tree node position by inputting an index function Γ via file absolute path; Step 3: obtaining slice of FBHTREE based on the leave node position in Step 2; Step 4: performing a hash computation on tree node position in the slice and hash value saved at another tree node position to obtain hash value of tree node position of one previous level till root hash value Y is obtained; Step 5: comparing the hash value Y and the root hash value R saved by the client.

### BACKGROUND OF THE INVENTION

### Field of the Invention

The present invention is related to a cloud service auditing method for cloud access in real time.

### Description of Related Art

With the increase of the popularity of the cloud, a lot of cloud service providers start to provide file access services. Presently, a lot of people often choose to rent network spaces on the cloud for software developments or providing website services. However, during the file access service of the cloud service providers, the security thereof cannot be ensured, and the files on the cloud server may be damaged due to improper saving of the cloud service provider, or even the occurrence of the situation where the server has been implanted with malware. Despite that some cloud service providers claim that their services can achieve security defense, in fact, clients cannot know whether the service providers are able to securely isolate and protect the cloud server. With the consideration of the occurrence of the following situations, when Client A rents a cloud disk for use on the cloud, but the cloud platform may shut down the cloud drive when Client A stops its use of the cloud drive, and it may only reload its image file during the next booting and use by the Client A. However, Client A has no clue whether the cloud service provider has securely shut down the cloud drive and preserved the file. In other words, Client A has cannot know whether the image file is being infected by virus due to the insecure saving by the cloud service provider during the shutdown period, or even being implanted with malware by hackers.

The aforementioned risks can be overcome by establishing the non-repudiation between the service provider and the client. When an issue occurs, the service provider can be proved to be innocent while allowing the client to prove no faults on his or her end, a method of auditing is utilized to determine whether either party is of fault or not. As long as the non-repudiation can be achieved, a commercial contract can be established between the client and the service provider. Such contract can be set for a price value according to the security level desired by the client. For example, if the data managed by the service provider is stolen or altered, then the service provider shall pay the indemnification amount specified in the contract with the client. However, the auditing shall be supported by proof. Such proof refers to the signed messages certified by both parties; therefore, it shall be checked every time before the execution of the application program or the access of files in order to ensure the security of the cloud platform completely.

### SUMMARY OF THE INVENTION

The present invention provides a method for auditing cloud access in real time. A first objective of the present invention is that a client obtains necessary information from a synchronization server SYS, comprising executing a function library comprising an index function Γ required by a program, and saving a root hash value R of a fully binary hash tree FBHTREE in the synchronization server SYS.

A second objective of the present invention is that the client obtains a leave node position corresponding to the fully binary hash tree FBHTREE by inputting an index function Γ via an absolute path of a file, and further adding 2^{N-1} to the leave node position in order to achieve a tree node position corresponding to the fully binary hash tree. In addition, a slice of the fully binary hash tree FBHTREE is obtained based on the leave node position in the previous step.

A third objective of the present invention is to perform a hash function computation on the tree node position in the slice of the fully binary hash tree FBHTREE and a hash value saved at another tree node position in order to obtain a hash value of a tree node position of one previous level.

A fourth objective of the present invention is that once the tree node position obtained is determined to be a tree root node, comparing the hash value Y and the root hash value R saved by the client; if the root hash value R saved by the client is identical with the hash value Y after computation, auditing is determined to be qualified; otherwise, it is determined to be disqualified.

A fifth objective of the present invention is that the client updates the hash value saved in the synchronization server SYS, referring to repeating Steps 1, 2, 3 and 4; and further performing a hash function computation on the tree node position in Step 4 and a hash value saved at another tree node position of the same level in order to obtain a hash value of a tree node position of one previous level for replacing the hash value of the same tree node position of the fully binary hash tree FBHTREE till a tree root node.

A sixth objective of the present invention is that the aforementioned hash function provided is SHA-256.

A sixth objective of the present invention is that the aforementioned index function Γ provided refers to Γ(file name)=SHA-256(file name)mod 2^{N-1}.

To facilitate the illustration of the aforementioned technical features and advantages of the present invention, the following provides a detailed description on embodiments of the present invention along with the accompanied drawings.

### BRIEF DESCRIPTION OF DRAWING

FIG. 1 shows a file folder tree structure;

FIG. 2 shows a hash value tree structure;

FIG. 3 shows a slice infrastructure diagram of a fully binary hash tree; and

FIG. 4 is a schematic view showing the comparison of the root hash values.

### DETAILED DESCRIPTION OF THE INVENTION

To illustrate the technical content, structural characteristics of the present invention as well as the objectives and technical effects thereof achieved, the following provides a detailed description of embodiments of the present invention along with the accompanied drawings.

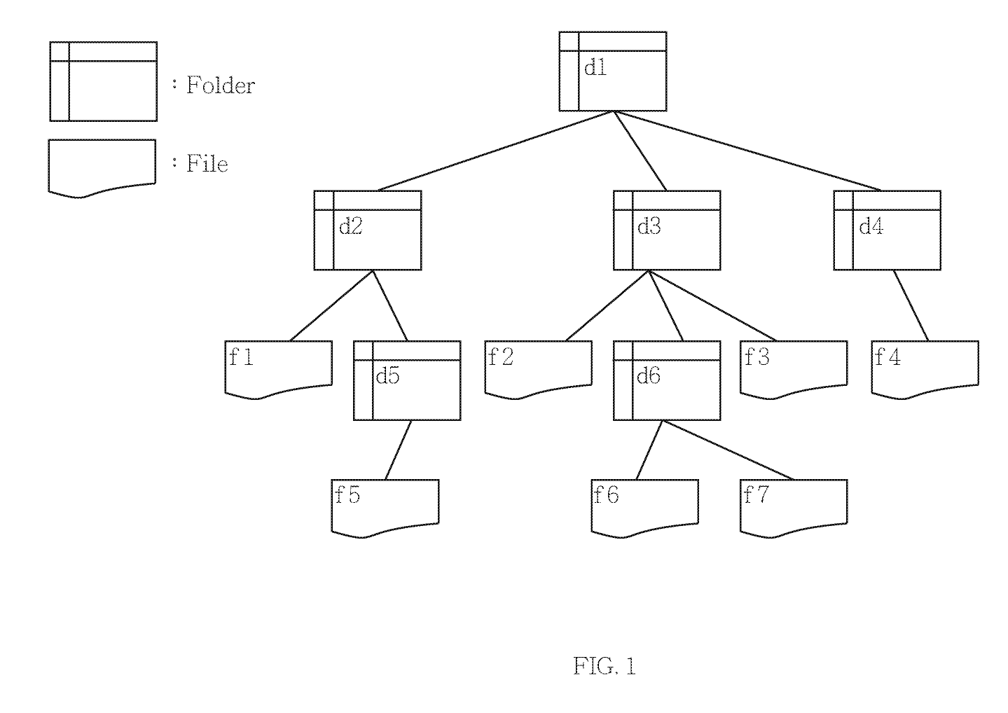

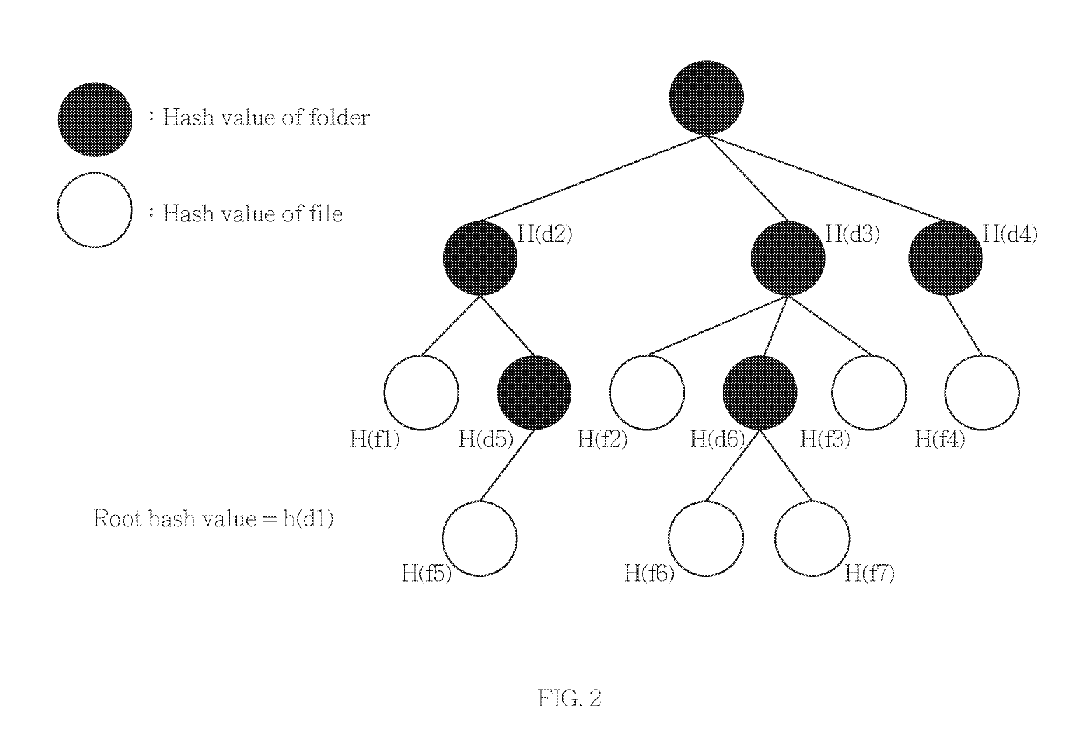

Please refer to FIGS. 1 and 2, in which FIG. 1 refers to a file folder tree structure, and FIG. 2 shows a hash value tree structure. As shown in FIG. 1, when a client opens to use the cloud service, the client then calculates each file in the library of the operating system and the Hash value in the folder as well as records such value. As shown in FIG. 2, calculations are made for the files and the folders layer by layer starting from nodes in the bottom layer; for example, h(d3)=h(h(f2)|h(d6)|h(f3)). In addition, the Hash value “h” at the final top end is called the root hash value. Due to the characteristic of cryptography encryption function, if the value of any one node is modified, then different root hash value would be obtained. Consequently, root hash value can be used to verify the integrity of the entire function library.

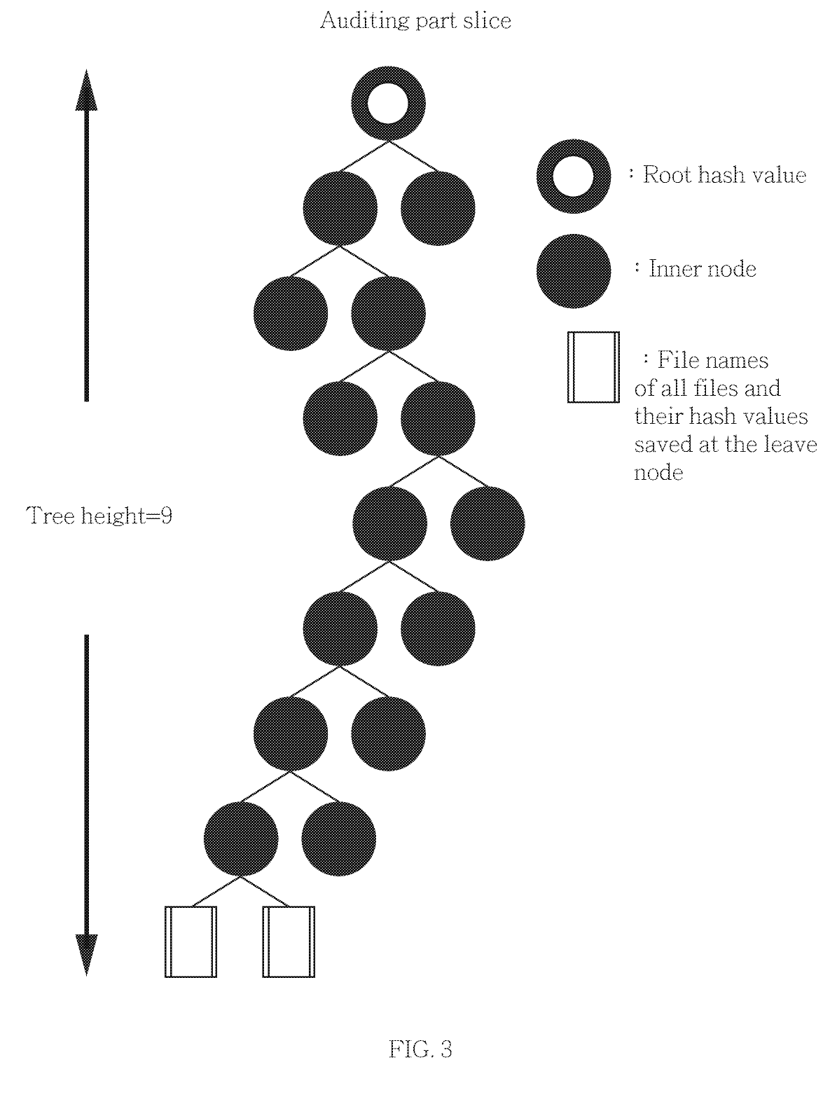

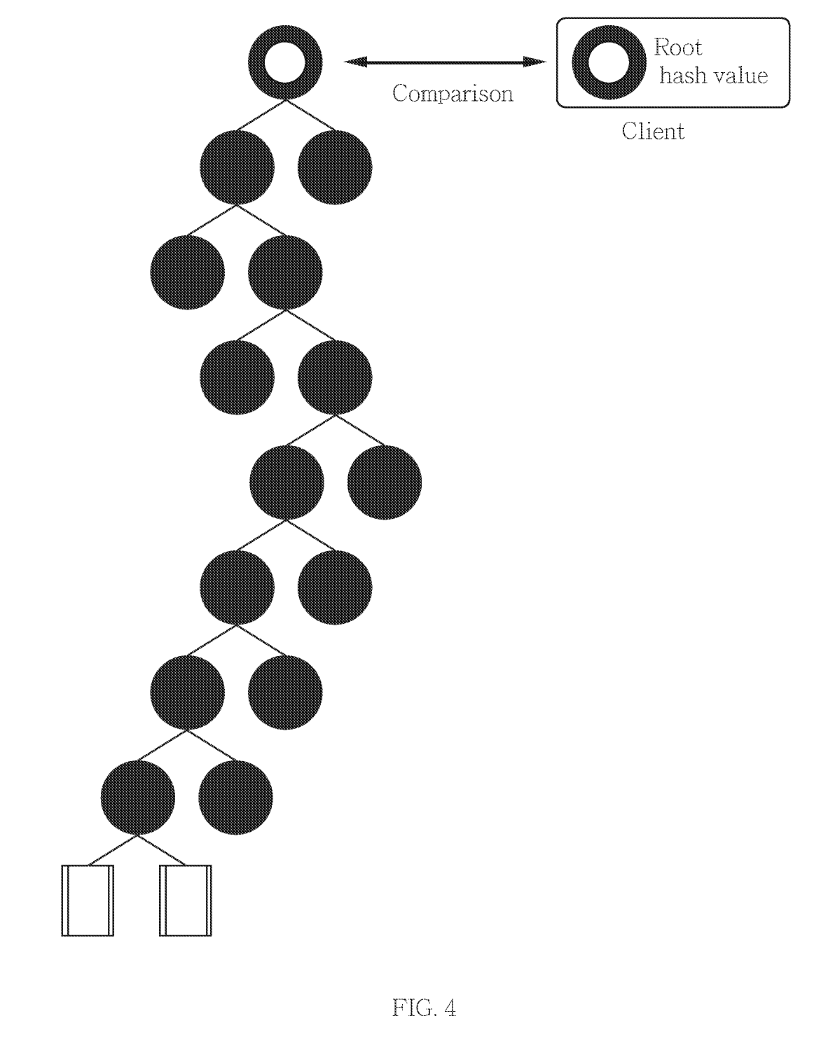

Please refer to FIGS. 3 and 4, in which FIG. 3 shows a slice infrastructure diagram of binary fully hash value, in which the hash value of leave node refers to the path names of all files saved at that leave node and the hash values connected to their hash values. FIG. 4 is a schematic view showing the comparison of the root hash values, and traditionally, it records the entire function library folder infrastructure, which is known as Merkle Tree. Such structure is saved in the cloud server, and the client saves the root hash value. In addition, every time when the client updates the saved file, re-computation on the hash values of all of the files and folders in the cloud server needs to be performed again in order to obtain a new root hash value, followed by saving such root hash value. However, the complexity of the computation and saving for such structure is too high and requires extensive period of time. Consequently, the present invention uses the structure of a fully binary hash tree FBHTREE in order to achieve the reduction of complexity, which can be mainly divided into three parts: leave nodes, inner nodes, root roots. A leave node refer to hash value of PB-pairs formed by a collection of Pair value, wherein the Pair value refers to the name of each file and the hash value of such file. Each file needs to pass through an index function Γ, wherein: Pair value=hash(file name|hash(file)), PB-pair=Pair value1|Pair value2| . . . |Pair value_{N}, hash value of leave node=hash(PB-pair), hash value of leave node of one pervious level=hash (Left child node|Right child node). The client can use the index function Γ in a computation to obtain the location of a leave node at which the file is saved. Accordingly, when the file is used next time, comparison between the root hash value Y computed from the slice of the leave node corresponding to the fully binary hash tree and the root hash value R saved by the client can be performed; if the two are identical to each other, it can be used to verify that the data on the cloud server is not changed. Details of the root hash value auditing algorithm are as shown in Algorithm 1 below:
Algorithm 1: According to the root hash value R saved by the client, finding the slice corresponding to the file in the fully binary hash tree FBHREE, and performing auditing on such file.
Assuming that the tree height of the fully binary hash tree FBHTREE is “N”, and the quantity of PB-pairs of the branch nodes for saving such file is “m”
I: refers to the leave node ID of the file
Ψ: refers to a one-dimensional array for saving the fully binary hash tree FBHTREE
H: refers to SHA-256 function
Γ: Index function, Γ(FileName)=SHA-256(FileName) mod 2^{N-1}
Y: refers to the root hash value re-computed
Input:
R: root hash value saved by the client
FileName: absolute path of the file
FileHash: hash value of the file
Output: result of whether the audit is qualified
(1) I=Γ(FileName)
(2) X=I+2^{N-1}//converting a leave node ID into a tree node ID
(3) Ψ [X]=h(Pair value₁|Pair value₂| . . . |(Pair valueₘ); Y=Ψ [X]; check whether
FileName and FileHash are correctly saved in a certain Pair value.
(4) WHILE (X≠1) DO//from the leave node at the lowest layer to the root node
IF X is an even number THEN
Y=H(Y)|Ψ[X+1])
ELSE
Y=H(Ψ[X−1])|Y)
END IF
X=└X÷2┘//round off unconditionally
END WHILE
(5) IF (R=Y)
RETURN TRUE
ELSE
RETURN FALSE

When the client wishes to update the file hash value saved in the fully binary hash tree, the updating hash algorithm Algorithm 2 is as follows:
Algorithm 2: Updating the file hash value in the fully binary hash tree.
Assuming that the tree height of the fully binary hash tree FBHTREE is “N”, and the quantity of PB-pairs of the branch nodes for saving such file is “m”
Γ: Index function, Γ (FileName)=SHA-256(FileName) mod 2^{N-1}
Input:
FileName: absolute path of the file
FileHash: hash value of the file
Ψ: refers to a one-dimensional array for saving the fully binary hash tree FBHTREE
Output: Ψ: refers to a one-dimensional array for saving the fully binary hash tree
FBHTREE modified
(6) I=Γ(FileName)
(7) X=I+2^{N-1}//converting a leave node ID into a tree node ID
(8) Ψ[X]=h(Pair value₁|Pair value₂| . . . |Pair valueₘ)//updated hash value, updating the FileName and FileHash in a certain Pair value
(9) WHILE (X≠1) DO//from the leave node at the lowest layer to the root node
IF X is an even number THEN
Ψ [X/2]=H(Ψ[X])|Ψ[X+1])
ELSE
Ψ [(X−1)/2]=H(Ψ[X−1])|Ψ[X])
END IF
X=└X/2┘/round off unconditionally
END WHILE
(10) RETURN Ψ
   It can be understood that although the present invention has been illustrated with preferred embodiments as disclosed above, such embodiments shall not be used to limit the present invention. Any person skilled in the art in this field is able to make modifications and refinements without deviating the spirit and scope of the present invention. Therefore, the scope of the present invention shall be based on the claims recited hereafter.

What is claimed is:

1. A method for auditing cloud access in real time, comprising the following steps:
Step 1: a client obtaining necessary information from a synchronization server (SYS), comprising executing a function library comprising an index function (F) required by a program, and saving a root hash value (R) of a fully binary hash tree (FBHTREE) in the synchronization server (SYS);
Step 2: the client obtaining a leave node position corresponding to the fully binary hash tree (FBHTREE) by inputting an index function (γ) via an absolute path of a file, and further adding 2^{N-1} to the leave node position in order to achieve a tree node position corresponding to the fully binary hash tree;
Step 3: obtaining a slice of the fully binary hash tree (FBHTREE) based on the leave node position in the previous step;
Step 4: performing a hash function computation on the tree node position in the slice and a hash value saved at another tree node position in order to obtain a hash value of a tree node position of one previous level till a root hash value (Y) is obtained; and
Step 5: comparing the hash value (Y) and the root hash value (R) saved by the client; if the root hash value (R) saved by the client is identical with the hash value (Y) after computation, auditing is determined to be qualified; otherwise, it is determined to be disqualified.

2. The method for auditing cloud access in real time according to claim 1, wherein the hash function is SHA-256.

3. The method for auditing cloud access in real time according to claim 1, wherein the index function (Γ) refers to Γ(file name)=SHA-256(file name)mod 2^{N-1}.

4. The method for auditing cloud access in real time according to claim 1, wherein the client updates the hash value saved in the synchronization server (SYS), referring to repeating Steps 1, 2, 3 and 4; and further performing a hash function computation on the tree node position in Step 4 and a hash value saved at another tree node position of the same level in order to obtain a hash value of a tree node position of one previous level for replacing the hash value of the same tree node position of the fully binary hash tree (FBHTREE) till a tree root node.
